(19) United States
(12) Patent Application Publication
(10) Pub. No.: US 2020/0034812 A1
(43) Pub. Date: Jan. 30, 2020

(54) SYSTEM FOR DYNAMIC SMART CART CONTENT NOTIFICATIONS

(71) Applicant: Walmart Apollo, LLC, Bentonville, AR (US)

(72) Inventors: Behzad Nemati, Springdale, AR (US); Arnabh Bhaumik, Bentonville, AR (US); Deepti Bisht, Bentonville, AR (US)

(21) Appl. No.: 16/515,736

(22) Filed: Jul. 18, 2019

Related U.S. Application Data
(60) Provisional application No. 62/703,505, filed on Jul. 26, 2018.

(51) Int. Cl. G06Q 20/20; B62B 5/00; G06Q 20/38

(52) U.S. Cl. CPC G06Q 20/208; G06Q 20/387; G06Q 20/203; B62B 5/0096

(57) ABSTRACT

Examples provide a set of smart shelves including sensors for generating sensor data associated with one or more items displayed on the set of smart shelves. If the shelf sensor data indicates an item is removed from a smart shelf, the smart shelf sends out an item notification, including item data associated with the removed item. The item notification is sent to a set of smart carts within a notification zone. A smart cart includes sensor devices generating cart sensor data associated with items placed inside the smart cart device. If the cart sensor data indicates the removed item is placed into one of the smart carts, the smart cart sends a confirmation message to the smart shelf and any other smart carts within the notification zone. The smart cart receiving the removed item updates a list of items in the cart to include the removed item.

### BACKGROUND

Retail store checkout lines frequently require a customer that has selected all the items they wish to purchase to stand in line and wait for a clerk or other personnel to manually scan each item in the customer's basket for checkout. self-checkout (SCO) systems enable the customer to manually scan items in a self-check process without waiting for the assistance of a clerk. However, there may be items which these SCO systems are unable to scan or process without assistance or approval by a clerk or a manager. Moreover, the customer may also have to wait in a line until an SCO becomes available. This is frequently a time-consuming, inefficient and frustrating process for customers.

### SUMMARY

Some examples provide a system for dynamic identification of cart contents via item notifications. A smart shelf device includes one or more items and a communications interface device. The communication interface device sends an item notification including item data associated with a set of items removed from a portion of the smart shelf device for a threshold removal time. A set of smart cart devices located within a notification zone of the smart shelf device includes a first smart cart device and a second smart cart device. The first smart cart device includes a control device. The control device includes a processor communicatively coupled to a memory. A set of one or more cart sensor devices generates sensor data associated with a set of selected items added to a storage area of the first smart cart device. A cart management component analyzes sensor data associated with a selected item added to the storage area within a threshold time-period of receiving the item notification. The cart management component determines whether the selected item conforms to an item removed from the smart shelf device. If the selected item conforms to a removed item, a verification component transmits a first cart confirmation message to the smart shelf device and the second smart cart confirming placement of the removed item into the first cart. A basket update component adds the removed item to a list of contents of the first smart cart. A cache manager component the at least one processor, deletes the item notification from a cart cache if all items in the set of removed items are added to the list of contents of the first smart cart.

Other examples provide a computer-implemented method for dynamically identifying items placed into a smart cart device. A communications interface device associated with a first smart cart device receives an item notification including item data associated with an item removed from a portion of a smart shelf device for a threshold removal time. A verification component analyzes sensor data generated by at least one sensor device associated with a set of selected items added to a storage area of the first smart cart device. The verification component determines if a selected item in the set of selected items conforms to the removed item. If item data for the selected item conforms to item data for the removed item, a verification component transmits a first cart confirmation message confirming addition of the removed item to the first smart cart device. If a threshold wait time expires prior to detecting addition of an item to the storage area conforming to the item data associated with the removed item a cache manager component removes the item notification from a cart cache.

Still other examples provide a smart cart device including a basket, a set of wheels, and a set of sensor devices generating sensor data associated with a set of selected items placed into the basket. A control device includes a processor communicatively coupled to a memory. A receiver device receives item notifications from a set of smart devices within a notification zone, an item notification comprising item data describing an item removed from a smart shelf device in the set of smart shelf devices. A transmitter device sends a cart confirmation to the set of smart shelf devices in response to detection of an item added to the basket conforming to the item data describing the item removed from the smart shelf device. A basket update component adds the item to a list of contents of the first smart cart on condition a cart confirmation is sent. A transaction completion component completes a transaction associated with the list of items if transaction completion input is received from a user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a system for dynamic monitoring of cart contents.

FIG. 2 is an exemplary block diagram illustrating a notification zone.

FIG. 3 is an exemplary block diagram illustrating a notification system for dynamic identification of cart contents.

FIG. 4 is an exemplary block diagram illustrating a smart cart device.

FIG. 5 is an exemplary block diagram illustrating a cart management component.

FIG. 6 is an exemplary block diagram illustrating a smart cart device having a plurality of sensor devices.

FIG. 7 is an exemplary block diagram illustrating a cross-section of a smart cart device having a set of weight sensors.

FIG. 8 is an exemplary block diagram illustrating a top view of a smart cart device including a sensor device on a track.

FIG. 9 is an exemplary block diagram illustrating a top view of a smart cart device having a sensor device on a track along a circumference of the basket.

FIG. 10 is an exemplary block diagram illustrating a top view of a sensor tunnel on a smart cart device.

FIG. 11 is an exemplary block diagram illustrating a smart shelf device.

FIG. 12 is an exemplary block diagram illustrating a smart shelf device having a plurality of items.

FIG. 13 is an exemplary block diagram illustrating a front view of a smart shelf device including a plurality of sections.

FIG. 14 is an exemplary block diagram illustrating a smart shelf device including a weight sensor.

FIG. 15 is an exemplary block diagram illustrating a set of sensor devices.

FIG. 16 is an exemplary flow chart illustrating operation of the smart cart device to monitor contents of a smart cart device.

FIG. 17 is an exemplary flow chart illustrating operation of the smart cart device to manage item notifications received from smart shelf devices.

Corresponding reference characters indicate corresponding parts throughout the drawings.

### DETAILED DESCRIPTION

A more detailed understanding can be obtained from the following description, presented by way of example, in conjunction with the accompanying drawings. The entities, connections, arrangements, and the like that are depicted in, and in connection with the various figures, are presented by way of example and not by way of limitation. As such, any and all statements or other indications as to what a particular figure depicts, what a particular element or entity in a particular figure is or has, and any and all similar statements, that may in isolation and out of context be read as absolute and therefore limiting, can only properly be read as being constructively preceded by a clause such as “In at least some examples, . . . ” For brevity and clarity of presentation, this implied leading clause is not repeated ad nauseum.

Referring to the figures, examples of the disclosure enable dynamic identification of items in a smart cart device based on messages transmitted between smart cart devices and smart shelf devices. In some examples, a cart management component receives notifications identifying items removed from smart shelves and/or notifications including sensor data describing items removed from smart shelves. An open item notification is a notification associated with one or more items removed from a shelf that is not yet accounted for in a smart cart (no cart confirmation messages received). A closed item notification is a notification describing one or more items removed from one or more smart shelves that have all been accounted for/claimed by one or more smart carts (cart confirmation messages received for all the removed items identified in the item notification). When an item notification is closed, the item notification can be deleted from the shelf device cache and/or the cache associated with each smart cart device that received the item notification.

The cart management component compares sensor data for items placed into the smart cart with the data describing items removed from the smart shelves to identify each item placed into basket or storage area of the cart. This enables efficient and automatic inventory of shopping cart contents without manually scanning each item in the cart at a point-of-sale (POS) device.

Aspects of the disclosure further enable the smart cart device to act as a POS device. In these examples, the smart cart device enables the user to complete a transaction to purchase items in the smart cart device. The provides more efficient self-checkout for increased customer checkout speed and improved customer satisfaction.

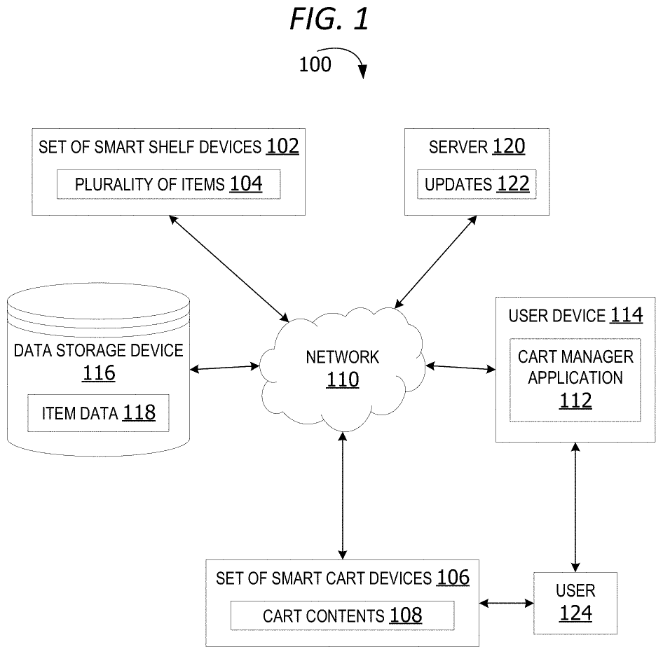

Referring again to FIG. 1, an exemplary block diagram illustrates a system 100 for dynamic monitoring of cart contents. In the example of FIG. 1, a set of one or more smart shelf devices 102. A smart shelf device in the set of smart shelf devices 102 is a display for storing or displaying a plurality of items 104. A smart shelf device can be implemented as a shelf, display, display freezer, refrigerated display, end-cap display, gondola shelf, warming rack, or any other type of display.

In at least some examples, when an item from the plurality of items 104 is removed from a smart shelf device, the smart shelf device sends a notification to a set of one or more smart cart devices 106 within a predetermined radius of the set of smart shelf devices 102. A smart cart device in the set of smart cart devices 106 is a buggy cart or basket for holding one or more items selected by a user 124 within a retail environment.

The retail environment can include a store or a section/area within a store. For example, but without limitation, a retail environment can include a grocery store, a pet supply store, an automotive parts store, an office supply store, etc. A retail environment can also include, without limitation, a grocery department, a home supply department, a meat department, a dairy department, an automotive parts department, etc.

If the item removed from a smart shelf display device matches an item placed into a smart cart device, the smart cart device updates an inventor of cart contents 108. The cart contents 108 is a list of items inside a storage area of the smart cart device. The smart cart device optionally sends a confirmation message acknowledging that the item removed from the set of smart shelf devices 102 was placed into one or the carts in the set of smart cart devices 106.

The notifications and confirmation messages are transmitted between the set of smart shelf devices 102 and the set of smart cart devices 106 via a network 110. The network 110 is implemented by one or more physical network components, such as, but without limitation, routers, switches, network interface cards (NICs), and other network devices. The network 110 can be any type of network for enabling communications with remote computing devices, such as, but not limited to, a local area network (LAN), a subnet, a wide area network (WAN), a wireless (Wi-Fi) network, or any other type of network. In this example, the network 110 is a WAN, such as the Internet. However, in other examples, the network 110 is a local or private LAN.

The user 124 can optionally access the cart contents 108, including the list of items currently in the smart cart, by linking a cart manager application 112 running on a user device 114 with the smart cart device via the network 110. The user can link the cart manager application 112 to a selected cart by scanning a barcode on the smart cart, entering a cart identifier (ID) into the application, scanning a barcode displayed on the user device 114 using a barcode scanner on the cart, entering a confirmation code into a user interface on the user device 114 or the smart cart device, or any other process for linking the user device with a selected smart cart.

The user device 114 represent any device executing computer-executable instructions. The user device 114 can be implemented as a mobile computing device, such as, but not limited to, a wearable computing device, a mobile telephone, laptop, tablet, computing pad, netbook, gaming device, and/or any other portable device. The user device 114 includes at least one processor and a memory. The user device 114 can also include a user interface device.

The system 100 can optionally include a data storage device 116 for storing data, such as, but not limited to item data 118. The item data 118 is data associated with items in the plurality of items 104. The item data 118 includes, without limitation, weight of an item, size of an item, name of an item, variety of an item, barcode number, item identification number, package dimensions of an item, color of a label, image(s) of an item, letters on an item package or label, images on item packaging or labels, item price, item discounts, assigned display location of the item, etc.

The data storage device 116 can include one or more different types of data storage devices, such as, for example, one or more rotating disks drives, one or more solid state drives (SSDs), and/or any other type of data storage device. The data storage device 116 in some non-limiting examples includes a redundant array of independent disks (RAID) array. In other examples, the data storage device 116 includes a database.

The data storage device 116 in at least one example is included within a computing device or associated with a computing device, such as the server 120. In other examples, the data storage device 116 is a remote data storage accessed by the computing device via the network 110, such as a remote data storage device, a data storage in a remote data center, or a cloud storage.

The server 120 represents any device executing computer-executable instructions (e.g., as application programs, operating system functionality, or both) to implement the operations and functionality associated with the server 120. The server can be implemented as a desktop personal computer, kiosk, tabletop device, cloud server, blade server, web server, or any other type of computing device. The server in other examples is implemented as a group of processing units or other computing devices.

In some non-limiting examples, the server 120 is optionally accessed by the set of smart shelf devices 102 and the set of smart cart devices 106 via the network 110. The server 120 can also optionally transmit updates 122 to the data storage device 116. For example, the server 120 can transmit updates 122 to item data 118 to the data storage device 116. The server 120 in another example sends updates to item prices, item discounts, item specials, clearance pricing or other display-related data to the set of smart shelf devices 102 and/or the set of smart cart devices 106. The smart shelf devices utilize the information to update digital pricing displays on the smart shelf devices. The smart cart devices utilize the updates 122 to calculate transaction totals when acting as a mobile POS device completing purchase transactions for items in the smart cart being purchased by the user 124.

In this manner, the system 100 provides checkout via the smart cart device where no manual scanning is necessary and without standing in line to checkout. As a customer picks up an item and places it in the smart cart, the smart cart is able to identify the item and add it to a cart inventory (list of items). The cart acts as a virtual POS device or can communicate with a physical POS device (user device) to complete transaction (purchase) of items in the cart.

In some non-limiting examples, identification of items is a collaboration between smart carts and smart shelves. When an item is picked up off a smart shelf, the shelf sends out a notification to smart carts in the notification zone (radius) that the identified item has been removed. If any of the carts within the radius detects a weight increase in the cart that corresponds (recognizes weight added to cart), the cart communicates back to shelf and any other carts within range to acknowledge that the removed item is received by the smart cart.

The smart carts in other examples retain the notification from a shelf in a cart cache for a time period. In one example, the time-period is ten seconds. When the ten seconds expires, the notification is removed/deleted from the cache. However, the examples are not limited to a ten second time-period. The time-period can be any configurable threshold time-period for retaining notifications in cache.

In another example, a shelf sends out a notification identifying multiple items removed/selected from the shelf (based on weight per item knowledge, and weight removed). If multiple carts confirm receipt of items that include every item identified in the notification (confirmation receipt totals the notification weight), the shelf and carts clear the notification from their memory/cache.

If the smart shelf sending out the notification does not receive any cart confirmations because a customer picked up the item but did not place the item into a smart cart device (customer is not using smart cart/basket), the shelf clears the notification after a threshold wait time. In one example, the wait time is ten seconds. In another example, the wait time is fifteen seconds. In still other examples, the wait time is any configurable time-period. The system treats the removed item as an item selected by a user for purchase outside of the smart cart system.

Likewise, if a smart cart in the set of smart cart devices detects a weight increase but there is no corresponding notification identifying an item having a weight corresponding to the weight increase, the smart cart queries the customer to input item information or scan item at the smart cart to add the item to the smart cart inventory (list of items) on the cart. If item identification is not received from the user, the system prompts the user to finish/complete the purchase transaction via a physical POS/traditional checkout or requests a manager or other personnel verify cart contents.

If multiple items are selected that have the same weight (multiple notifications from shelves indicating an item weight that is substantially similar), then the smart cart that detects an item added to the cart presents a list of options from those multiple notifications/multiple removed items. The user selects the correct one or more items added to the cart from the list of options to confirm the item selection.

If an item removed from a shelf is an item having multiple different varieties for the same product, the smart shelf may be unable to determine which variety was removed from the shelf. For example, a shelf containing varieties of yogurt can include many different flavors for the same brand, same weight and same type of item packaging making it difficult for the smart shelf to distinguish between different varieties when yogurt is removed. In this example, the smart cart prompts the user to validate/select/confirm the variety (flavor) selected.

If a smart shelf detects an increase in weight due to an item being placed on the shelf where it does not belong (incorrect/misplaced item), the smart shelf device sends an alert to a user device associated with a manager or other personnel. If a customer or store personnel picks up the misplaced item, the shelf does not send out a notification for the removal of the misplaced item. An item notification is only sent out by a smart shelf for items that are assigned for display on that smart shelf device.

In other examples, analytics performed to identify cart contents based on sensor data generated on one or more smart carts and item notifications received from one or more smart shelves. The cart content analytics in some examples are performed entirely on a single smart cart device. In other examples, a portion of the analytics are performed on a first smart cart device while another portion of the cart content analytics are performed on one or more other smart cart devices within the retail environment.

The analytics performed to identify items removed from a smart shelf device are performed entirely by a smart shelf device in some examples. These analytics include analyzing sensor data generated by sensor devices attached to the smart shelf device or in communication with the smart shelf device, such as a camera. In another example, a portion of the removed item identification analytics are performed by the smart shelf device while other portions of the removed item identification analytics are performed by one or more smart cart devices within the notification zone. This enables processing tasks to be subdivided among multiple processors on multiple different devices for increased efficiency and improved utilization of resources.

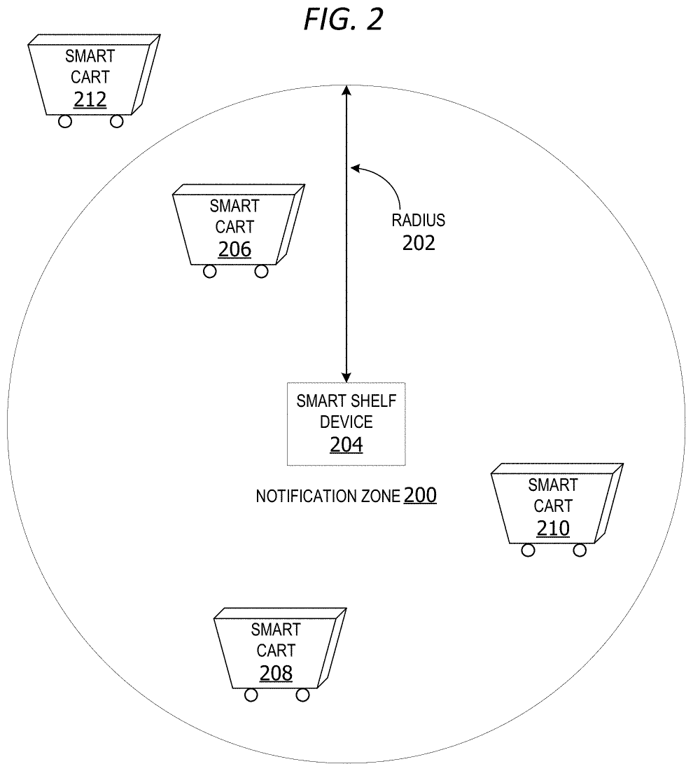

FIG. 2 is an exemplary block diagram illustrating a notification zone 200. The notification zone 200 is defined by a radius 202 from a selected smart shelf device 204. The smart shelf device 204 can be implemented as a single shelf, two or more shelves, a display case, a display bin, a refrigerated display, a freezer display, a rolling cart display, or any other type of product display device in a store. A shelf can be a wall-mounted shelf, a gondola shelf, an end-cap shelf, a tiered shelf, or any other type of shelf. In some example, the smart shelf device 204 is implemented as a shelf in the set of smart shelf devices 102 in FIG. 1.

The smart shelf device 204 transmits notifications, queries, and/or other messages to smart carts within the notification zone 200. The radius is any user-configurable radius or distance from the smart shelf device 204. In some example, the radius 202 is five feet. In other examples, the radius is twenty feet. In still other examples, the radius 202 is a distance calculated to generate a notification zone encompassing a shelf, display or aisle. In other examples, the notification zone is generated to encompass a portion of one or more shelves, a portion of one or more displays and/or a portion of one or more aisles.

In this non-limiting examples, when an item is removed from the smart shelf device 204 for a predetermined time-period, the smart shelf device 204 sends a notification including item data associated with the removed item to smart carts within the notification zone 200. The item data can include an identification of the item. For example, if the item is a jar of kosher spear pickles, the item notification sent to the smart carts includes an identification of the jar of kosher spear pickles. In another example, the item notification includes barcode data, such as barcode scanner data, radio frequency identification (RFID) tag data, quick response (QR) code data, matrix barcode data, universal product code (UPC) code data, or other item identifier data identifying a type of the item or a specific instance of the item.

In other examples, if the removed item is unidentified, the item data includes data associated with the item which is known by the smart shelf device. For example, the item data can include a weight of the item, a footprint of the item, a time of item removal, an image of the item, a list of items displayed on the shelf at or near the location of the removed item, etc.

In this non-limiting example, the smart shelf device 204 sends an item notification is sent to the smart cart 206, the smart cart 208 and the smart cart 210 within the notification zone of the smart shelf device 204. The item notification sent by the smart shelf device is not sent to/received by the smart cart 212 located outside the notification zone 200.

The smart carts 206, 208 and 210 within the notification zones are carts, buggies or baskets having a communications device for receiving notifications and/or sending confirmation/acknowledgement messages back to the smart shelf device. The smart carts 206, 208 and 210 can be implemented as carts, such as, but not limited to, the set of smart cart devices 106 in FIG. 1.

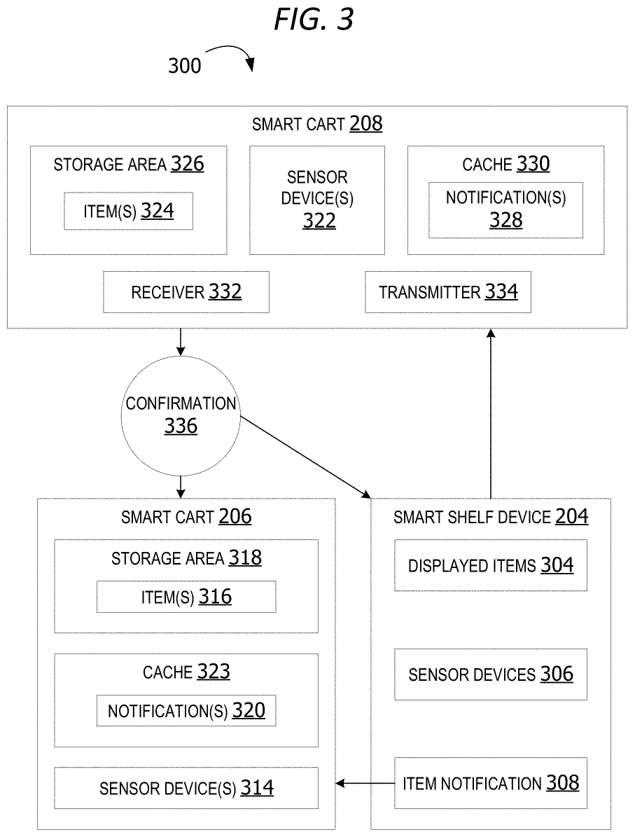

FIG. 3 is an exemplary block diagram illustrating a notification system 300 for dynamic identification of cart contents. A smart shelf device 204 including one or more displayed items 304 and one or more sensor devices 306, such as, but not limited to, a shelf in the set of smart shelf devices 102 in FIG. 1 and/or the smart shelf device 204 in FIG. 2.

The sensor devices 306 include one or more sensor devices for generating sensor data associated with the displayed items 304. The sensor devices 306 can include one or more scanner devices, one or more image capture devices, one or more pressure sensors, one or more weight sensors or any other devices for generating data associated with the items. A scanner device can include a UPC code reader, a matrix barcode reader, an RFID tag reader, a QR code reader, or any other type of scanner device.

When an item is removed from the smart shelf device 204, the sensor devices 306 detect the item removal. In one non-limiting example, a weight sensor in the set of sensor devices 306 detects a decrease in weight when one or more items are removed. In another example, a pressure sensor in the set of sensor devices 306 detects a change in pressure on the pressure sensor when one or more items are removed from the smart shelf device 204. In another example, a motion sensor in the sensor devices 306 detects motion when one or more items are removed from the smart shelf device 204.

When an item is removed from the smart shelf device 204, the smart shelf device 204 sends an item notification 308 to every smart cart in a notification zone of the smart shelf device 204. In this example, the smart shelf device 204 sends the notification to a smart cart 206 and a smart cart 208. The smart cart 206 and the smart cart 208 are carts, such as, but not limited to, a cart in the set of smart cart devices 106 in FIG. 1 and/or the smart carts 206-212 in FIG. 2.

The smart cart 206 in this example includes one or more sensor device(s) for detecting item(s) 316 placed into a storage area 318 of the smart cart 206. The storage area 318 is an interior portion of the smart cart configured to hold one or more items. The storage area can be implemented as a basket, a wagon, a bag, or other container.

The smart cart 208 in this non-limiting example includes one or more sensor devices 322 for detecting one or more item(s) 324 added to a storage area 326 of the smart cart 208.

The sensor device(s) 314 and/or sensor device(s) 322 can include any type of sensor for gathering sensor data associated with the item(s) 316. The sensor device(s) 314 can include, without limitation, one or more scanner devices, one or more image capture devices, one or more pressure sensors, one or more weight sensors or any other devices for generating data associated with the items. A scanner device can include a UPC code reader, a matrix barcode reader, an RFID tag reader, a QR code reader, or any other type of scanner device.

The smart cart 206 stores the notification(s) 320 received from smart shelf devices 204 in a cache 323 on the smart cart 206, such as, but not limited to, the item notification 308 in FIG. 3 above. The smart cart 208 stores notification(s) 328 in a cache 330 on the smart cart 208. The cache 323 and/or 330 can be implemented in a memory device or other data storage device on the smart cart.

The smart cart 208, in this non-limiting example, receives the item notification 308 from the smart shelf device 204 via a receiver 332 device on the smart cart 208. The receiver 332 can be implemented as a beacon device, a BLUETOOTH®”, a network device, a cellular signal, or any other device for receiving notifications from smart shelves.

The smart cart 208 compares the item data received in the item notification 308 with sensor data generated by the sensor device(s) 322 on the cart. If the removed item identified in the item notification 308 matches an item in the item(s) 324 placed into the storage area 326, the smart cart 208 sends a confirmation 336 message to the smart shelf device 204 and the smart cart 206 acknowledging receipt of the item removed from the smart shelf device 204.

The confirmation 336 message (acknowledgement) can be sent via a transmitter device 334. The transmitter device 334 can be implemented as a beacon device, a BLUETOOTH®”, a network device, a cellular signal, or any other device for sending to one or more other devices. In this example, the receiver 332 and the transmitter 334 are separate devices. In other examples, the receiver 332 and the transmitter 334 are implemented as a single device.

Upon receiving the confirmation 336, the smart cart 206 deletes the item notification 308 from the cache 323. In other examples, if the smart cart 206 does not receive a confirmation 336 from any other smart cart and the smart cart 206 does not identify the removed item in the item(s) 316 placed into the storage area 318, the smart cart 206 maintains the item notification 308 in the cache 323 until a threshold wait-time expires. Upon expiration of the wait time, the smart cart 206 deletes the item notification 308 from the cache.

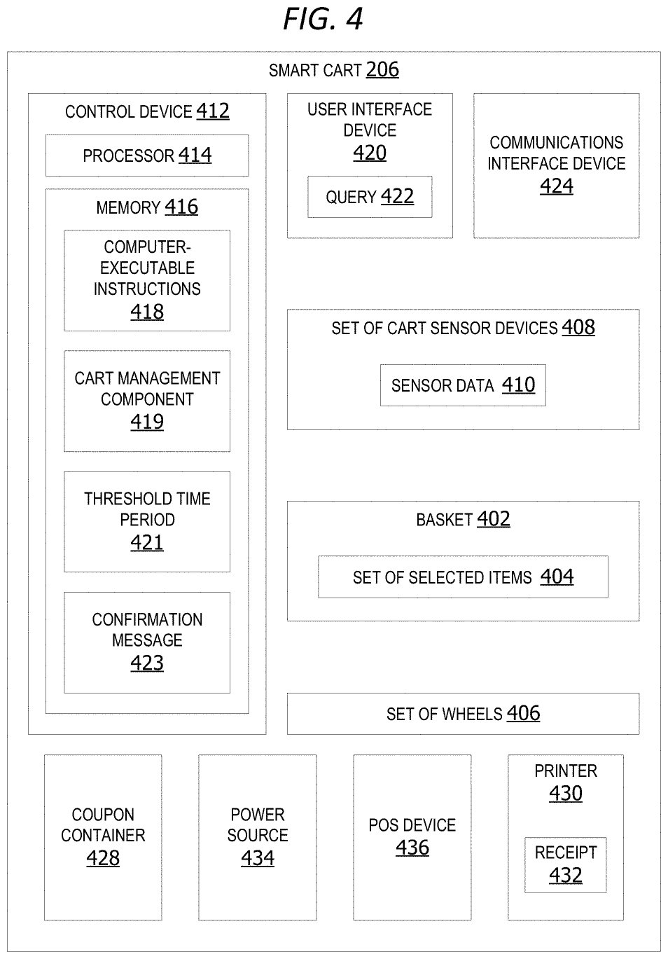

FIG. 4 is an exemplary block diagram illustrating a smart cart device 206. The smart cart device 206 in some examples includes a basket 402 storing a set of items 404. The set of items can be a null set, a single item, as well as two or more items. A set of wheels 406 in this example is attached to a bottom portion (underside) of the basket 402. The set of wheels 406 is a set of one or more wheels (rollers). In this non-limiting example, the set of wheels 406 is a set of four casters permitting the smart cart device 206 to roll backwards, forwards or turn.

The smart cart device 206 includes a set of cart sensor devices 408 generating sensor data 410 associated with the set of selected items 404 in the basket. The set of cart sensor devices 408 includes one or more sensor devices, such as, but not limiting to, a camera, a barcode scanner, an RFID tag reader, a pressure sensor, a weight sensor (scale), or any other type of sensor device. The set of cart sensor devices 408 can be attached to an interior portion of the basket, such as a side, rim, lip, or other member of the basket 402. One or more of the sensor devices can alternatively be attached to a bottom portion of the basket 402.

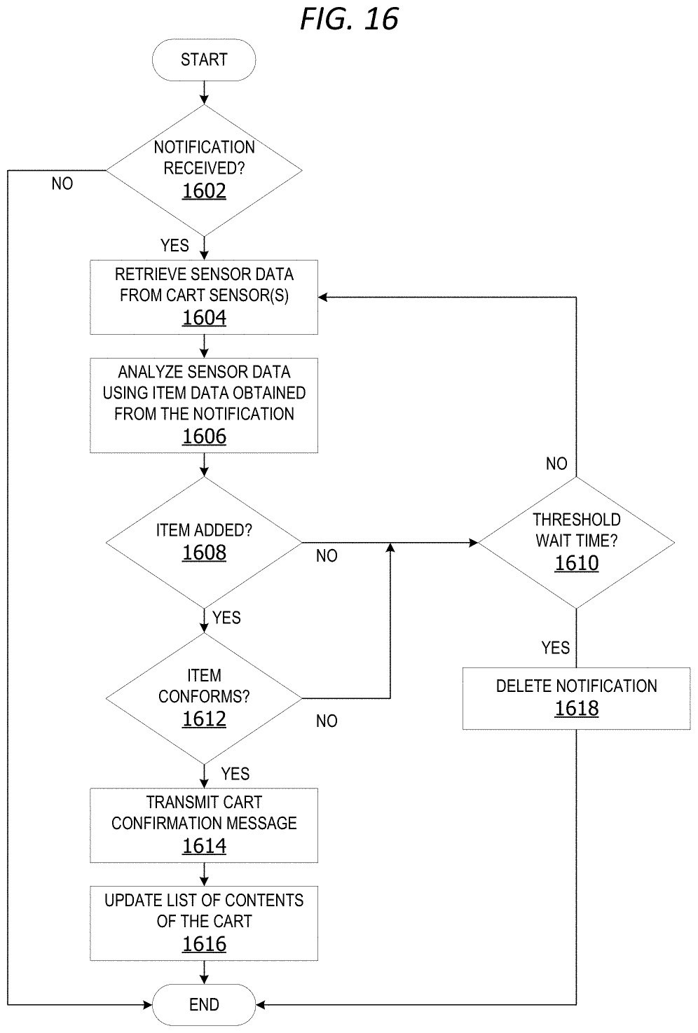

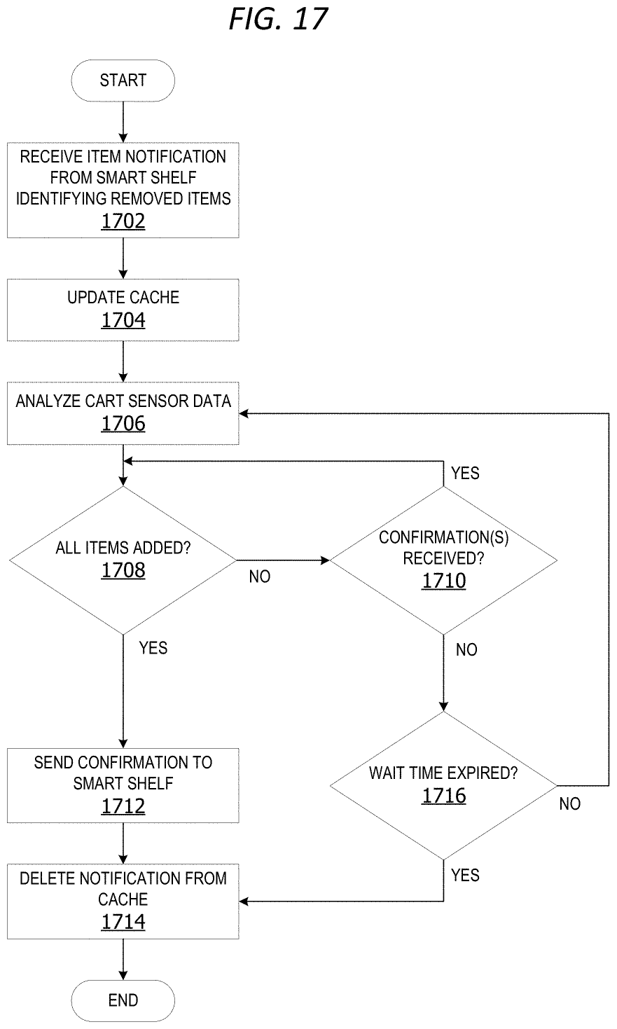

A control device 412 on the smart cart device 206 includes a processor 414 and a memory 416 communicatively coupled to the processor 414. The processor 414 includes any quantity of processing units and is programmed to execute computer-executable instructions 418. The computer-executable instructions 418 can be performed by the processor 414 or by multiple processors within the smart cart device 206 or performed by a processor external to the smart cart device 206. In some examples, the processor 414 is programmed to execute instructions such as those illustrated in the figures (e.g., FIG. 16 and FIG. 17).

The smart cart device 206 further has one or more computer-readable media such as the memory 416. The memory 416 includes any quantity of media associated with or accessible by the smart cart device 206. The memory 416 can be internal to the smart cart device 206 (as shown in FIG. 1), external to the smart cart device 206 (not shown), or both (not shown).

The memory 416 stores data, such as one or more applications. The applications, when executed by the processor 414, operate to perform functionality on smart cart device 206. The applications can communicate with counterpart applications or services such as web services accessible via a network, such as the network 110 in FIG. 1. For example, the applications can represent downloaded client-side applications that correspond to server-side services executing in a cloud.

The smart cart device 206 can optionally include user interface device 420 on the cart. The user interface device 420 can include, without limitation, a display screen, speaker, a microphone, a touch screen, or any other type of input/output device.

The user interface device 420 includes a graphics card for displaying data to the user and receiving data from the user. The user interface device 420 can also include computer-executable instructions (e.g., a driver) for operating the graphics card. Further, the user interface device 420 can include a display (e.g., a touch screen display or natural user interface) and/or computer-executable instructions (e.g., a driver) for operating the display. The user interface device 420 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor.

In some non-limiting examples, the user interface device 420 outputs a query to the user operating the smart cart device 206, such as a query 422. The query 422 can include a request for the user to identify an item placed into the basket 402. In another example, the query 422 includes a request the user identify an item removed from the basket 402.

In some examples, the smart cart device 206 optionally includes a communications interface device 424. The communications interface device 424 includes a network interface card and/or computer-executable instructions (e.g., a driver) for operating the network interface card. Communication between the smart cart device 206 and other devices, such as but not limited to a smart shelf device or other smart cart devices, can occur using any protocol or mechanism over any wired or wireless connection. In some examples, the communications interface device 424 is operable with short range communication technologies such as by using near-field communication (NFC) tags.

The communications interface device 424 in this example receives item notifications from smart shelf devices and/or other smart cart devices within a notification zone of the smart cart device 206. An item notification includes item data describing an item removed from a smart shelf device in the set of smart shelf devices. The communications interface device 424 sends a cart confirmation to one or more smart shelf devices and/or any smart cart devices in range of the smart cart device in response to the smart cart device detecting addition of an item to the basket 402 conforming to an item removed from a smart shelf.

The memory 416 in some examples stores one or more computer-executable components. Exemplary components include a cart management component 419. The cart management component 419 in this example analyzes the sensor data 410 generated within a threshold time-period 421 of receiving an item notification to determine whether the removed item described in the item notification conforms to at least one item in the set of selected items 404 in the basket 402. If the item identified in the item notification matches an item placed in the basket, the communications interface device 424 transmits a cart confirmation message 423 identifying the removed item as detected in the smart cart device. The confirmation message 423 is sent any smart carts and smart shelves within a predetermined range of the smart cart device 206.

The cart management component 419 adds the item to a list of contents (inventory) stored on the memory 416 of the smart cart device 206. The cart management component 419 deletes the item notification from a cart cache on condition all items in the set of removed items are added to the lit of contents of the first smart cart.

When the user operating the smart cart device 206 has completed their shopping (finished selecting items to purchase), the user can complete a purchase transaction to pay for the set of selected items 404 via a POS device 426 on the smart cart device 206. The POS device 426 completes a transaction associated with the set of selected items 404 using transaction data (payment data) received from the user.

The POS device 426 can be implemented as a separate payment device, such as a debit cart/credit card reader attached to the smart cart device. In other examples, the POS device 426 is integrated into the user interface device 420. In still another example, the POS device 426 is implemented via an application on a user device associated with the user, such as, but not limited to, the user device 114 in FIG. 1.

The cart management component 419 in this example, calculates a payment total for the set of selected items 404 based on pricing data for the item(s). A user can scan coupons or other discount materials via a scanner device on the cart. The smart cart device 206 can optionally include a physical coupon container 428 configured to accept physical coupons utilized during completion of the transaction.

The smart cart device 206 transmits transaction data to the cart manager application on the user device. The user completes the transaction by providing payment on the cart manager application. For example, a user can provide credit card information, debit card information or other payment information via the application on the user device. A physical printer device 430 can be included on the smart cart device 206 to print a receipt 432 documenting completion of the transaction.

The smart cart device 206 can also optionally include a power source 434 to power the control device, the set of sensor devices, and/or the printer. The power source can include, without limitation, one or more batteries, regenerative braking system, or any other type of power source.

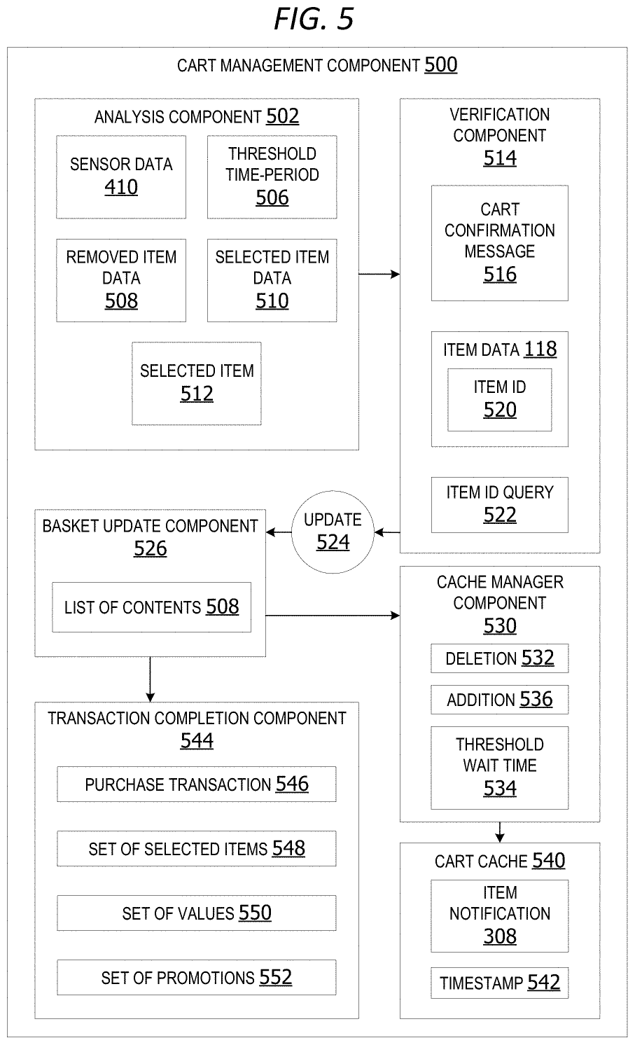

FIG. 5 is an exemplary block diagram illustrating a cart management component 500. The cart management component 500 is a component on a smart cart device for dynamically identifying the contents of the smart cart, such as, but not limited to, the cart management component 419 in FIG. 4.

The cart management component 500 includes an analysis component 502 that analyzes sensor data 410 generated by sensor device(s) on the smart cart as one or more items are added to the smart cart's basket storage area. The sensor data 410 in some examples is sensor data generated within a threshold time-period of receiving an item notification from a smart shelf.

The analysis component utilizes the sensor data and item data included in the item notification to determine whether one or more items removed from any smart shelves within notification range of the smart cart match/conform to any items added to the smart cart. In one example, the cart management component 500 obtains removed item data 508 describing an item removed from a smart shelf. The removed item data 508 can include, without limitation, barcode data for the item, the weight of the removed item, the footprint of the removed item, dimensions of the removed item, color of the packaging on the removed item, etc.

The analysis component 502 generates selected item data 510 describing a selected item 512 placed into the basket of the smart cart by a user (shopper). The selected item data 510 includes, without limitation, the weight of the item, barcode data for the item, an identification of the item, item footprint, packaging dimensions, color of item packaging or label, etc. The analysis component 502 compares the selected item data 510 with the removed item data 508 to determine if the item removed from the smart shelf was placed into the selected smart cart.

In some examples, the analysis component 502 compares weight data generated by at least one weight sensor on the smart cart with item data, including weight data for the item removed from the smart shelf, to determine whether the selected item 512 added to the cart matches at least one of the items in the set of removed items identified in the item notification 308.

In other examples, the analysis component 502 compares image data generated by at least one image capture device on the smart cart with the removed item data 508, including image data associated with one or more items removed from the smart shelf, to determine whether the at least one selected item added to the storage area of the first smart cart device matches at least one of the items identified in the item notification 308.

If one or more items placed in the basket of the smart cart match one or more items removed from one or more smart shelves, a verification component 514 transmits a cart confirmation message 516 identifying the at least one item to the smart shelf device that sent the item notification. The cart confirmation message 516 is also sent to/received by other smart cart devices within the notification zone of the smart shelf.

The cart confirmation message 516 in some examples include item data can 118 associated with the removed item placed into the smart cart. The item data can 118 can include an item identifier (ID) associated with the removed item.

If a selected item 512 placed into the smart cart device fails to conform to any item identified in an item notification received from a shelf, the verification component 514 outputs an item ID query 522 to the user via a user interface device on the cart or via an application on a user device. If the user fails to identify the selected item, the verification component 514 transmits a request for assistance to a manager or other personnel to visually inspect the selected item 512 and manually identify the selected item 512 or scan an item barcode using a barcode reader.

The verification component in other examples outputs the item ID query 522 to a user interface device associated with the smart cart device or a user device if the selected item 522 added to the smart cart conforms with two or more items identified in the item notification 308. The item ID query 522 prompts the user to manually identify the selected item 512 from a list identifying the two or more different items having item data matching the selected item data 510. The query can also request the user manually scan a barcode of the selected item 512 using a barcode reader device to identify the selected item 512.

The verification component 514 in other examples outputs an item ID query 522 to a user via a user interface device associated with the smart cart device if the sensor data 410 generated by the set of cart sensor devices indicates removal of at least one item from the cart storage area that is not identified. The query prompts the user to identify the item(s) removed from the smart cart device via scanning the item with a barcode scanner or entering the item identification into the user interface device. In other examples, the query includes a list of items from the list of contents which can be the item removed from the cart. The user is prompted to select the item removed from the cart from the list of choices.

The verification component 514 sends an update 524 to a basket update component 526. The basket update component 526 updates the list of contents 528. The list of contents 528 is a list of items in the storage area of the smart cart. The list of contents 528 is an inventory of items selected for purchase by the shopper. The list of contents is stored on the smart cart device. The update 524 adds the selected item 512 to the list of contents 508.

A cache manager component 530 performs a deletion 532 removing the item notification 308 from a cart cache 540 if all items identified in the item notification are added to the list of contents 528 of the smart cart. The cache manager component 530 deletes the item notification if all items identified in the item notification are added confirmed by one or more smart cart devices in the range of the smart shelf. In other words, even if the selected smart cart does not receive every item identified in the item notification, the item notification can be deleted if one or more other smart carts confirms receipt of the remaining items identified in the item notification 308.

In other examples, if all the items identified in the item notification 308 are not confirmed as received by one or more smart carts, the cache manager component 530 deletes the item notification after a threshold wait time 534 after receiving the item notification expires. The cache manager component 530 determines if the threshold wait time is expired by computing a time stamp 542 identifying the time at which the item notification is received with a current time. If the duration of time since the item notification was received is equal to or greater than the threshold wait time, the notification is removed from the cache. If the wait time is not expired, the cart continues analyzing sensor data to determine if the item(s) removed from the shelf are being added to the cart.

A transaction completion component 544 provides a POS function to enable completion of a purchase transaction 546 to purchase a set of selected items 548 in the smart cart device based on a set of values 550 and/or a set of promotions associated with each item in the list of contents of the smart cart device. The set of values 550 in some examples includes a price for each item in the set of selected items 548. The set of promotions 552 in some examples includes coupons, rebates, mark-down prices, special deals, or other discounts associated with purchase of one or more items.

In one example, a server or other computing device sends out storewide (local) pricing updates/promotions to smart carts within the retail environment. The smart carts are updated as to price changes, promotions, discounts periodically. For example, pricing and promotions can be sent out on a daily basis. A user can also scan coupons via a barcode scanner on a user device or on the smart cart device. The user can place a physical hardcopy of the coupon into a coupon container on the cart. If the customer wants to complete the transaction with cash, the customer can take cash to a traditional checkout, a self-checkout, a customer service or other cash station/kiosk.

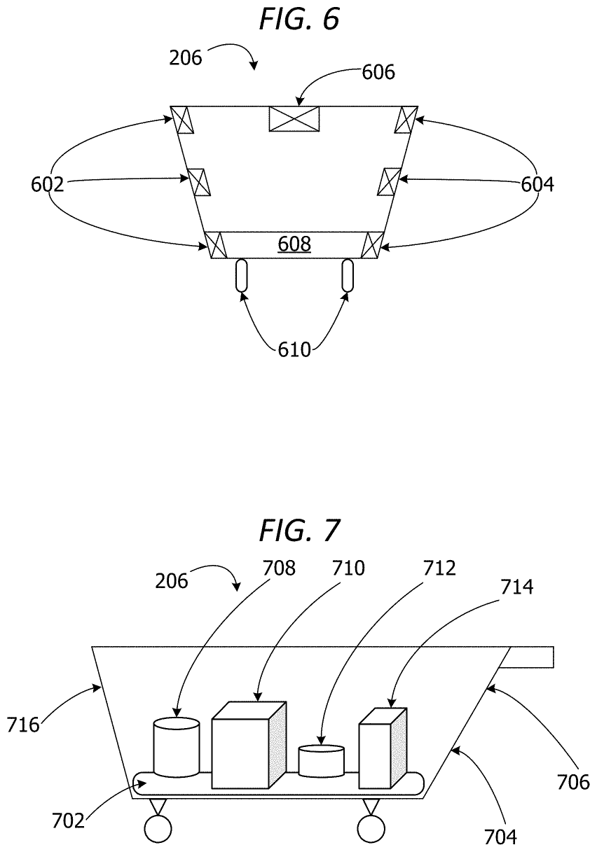

FIG. 6 is an exemplary block diagram illustrating a smart cart device 206 having a plurality of sensor devices associated with the cart. In this non-limiting example, a set of sensor devices 602 are attached to one side of the smart cart device 206, a set of sensor devices 604 is attached to another side of the smart cart device 206, a sensor device 606 is attached to a back portion of the smart cart device 600. The sensors can include barcode readers, image capture devices, RFID tag readers, QR code readers, or any other type of sensor device.

In this non-limiting example, the smart cart device 206 includes a weight sensor 608 is attached to a bottom portion of the smart cart device. The weight sensor registers changes in weight as items are added to the cart or removed from the cart.

FIG. 7 is an exemplary block diagram illustrating a cross-section of a smart cart device 206 having a set of weight sensors. In this example, a weight sensor 702 is located on the bottom 704 of a basket 706. As items, such as item 708, item 710, item 712 and/or item 714, are placed into the basket 706 or removed from the basket 706. In other examples, sensor devices optionally attach to a side 716 of the cart 700, a handle 718 of the cart or any other portion of the basket 706.

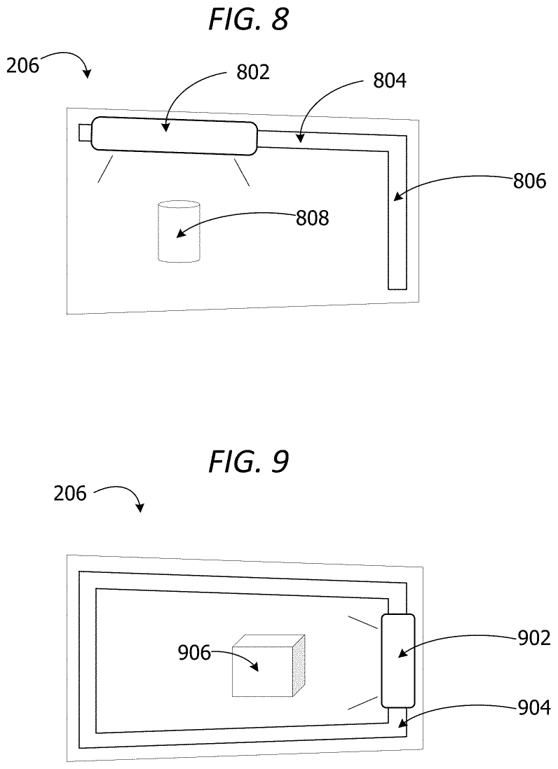

FIG. 8 is an exemplary block diagram illustrating a top view of a smart cart device 206 including a sensor device 802 on a track 804. The sensor device 802 moves along the track 804 along the circumference of the basket 806 to scan items, such as item 808, as the item is placed into the basket. If the item is placed into the basket at a location that is sub-optimal for scanning by the scanner device 802, the scanner device 802 slides along the track 804 to a position closer to the item 808 for scanning.

The smart cart device 206 in this non-limiting example, includes a single sensor device 802. In other examples, the smart cart device 206 includes two or more sensor devices. In this example, the track 804 extends around two sides of the perimeter of the basket 806. In other examples, the track 804 extends along a single side of the lip or perimeter of the basket, extend along three sides of the lip/perimeter of the basket, and/or extend along the entire perimeter of the basket.

FIG. 9 is an exemplary block diagram illustrating a top view of a smart cart device 206 having a sensor device 902 on a track 904 along a perimeter of the basket. The track 904 can be located along a top edge of the basket, along a middle portion of the basket or along a bottom portion of the basket. In other words, the sensor device attached to the track can be located at any level within the basket (top, bottom or mid-length). The sensor device 902 slides or moves along the track 904 to a position placing the sensor device within range of a barcode or other identifying marking or feature on the item 906.

In this example, the track 904 extends along the entire perimeter of the basket. In other examples, the track 904 extends along a single side, two sides or three sides of the basket. The sensor device slides forward and backward or side-to-side along the track (rails) across the top of the basket to allow for placing item in front or back of the basket. The sensor device moves autonomously in real-time based on the location of the item being placed into the basket.

In this non-limiting example, the user does not need to locate the barcode or other item identifier on the item prior to placing the item in the basket. The user drops the item into the basket, and the scanner device slides along the track 13to a position enabling the scanner device to scan the barcode on the item.

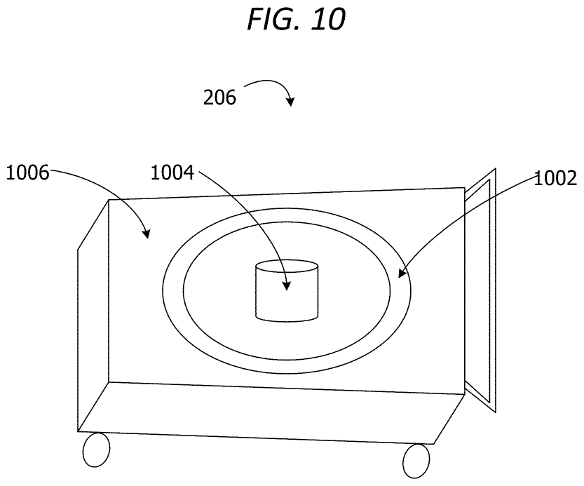

FIG. 10 is an exemplary block diagram illustrating a top view of a sensor tunnel 1002 on a smart cart device 206 for scanning an item 1004 or generating sensor data associated with the item 1004 as the item 1004 is placed into the smart cart device 206. In some examples, the smart cart device 206 includes a retractable top 1006 defining a space restricting access to the storage area of the smart cart to the sensor tunnel. In other words, the user is only able to place the item 1104 into the cart via the sensor tunnel. The top is retractable to enable easy access to the cart contents (items in the basket) for removal of items and/or checkout.

In some examples, the retractable top is placed across an aperture associated with the basket to prevent placement of items into the basket without passing through the sensor tunnel. The top can optionally be transparent to enable viewing of items in the cart. The top is retractable for inserting items too large to pass through the tunnel and/or unloading the cart.

The sensor tunnel mounts to the smart cart and scans multiple sides of an item as the item passes through the tunnel. The sensor tunnel can include barcode scanners, RFID tag readers, cameras or other sensor devices. In one example, the barcode scanner scans multiple sides of the item to detect/read a barcode on an item. In other words, the barcode on an item can be scanned by the sensor tunnel regardless of which side of the item or which portion of the item the item barcode is placed because the sensor tunnel is capable of scanning multiple sides of the item simultaneously.

In this non-limiting example, the user does not need to locate the barcode or other item identifier on the item prior to placing the item in the basket. The user drops the item through the sensor tunnel attached to an aperture in the basket. The sensors in the sensor tunnel scans multiple sides of the item as the item falls through the tunnel to detect/scan the barcode.

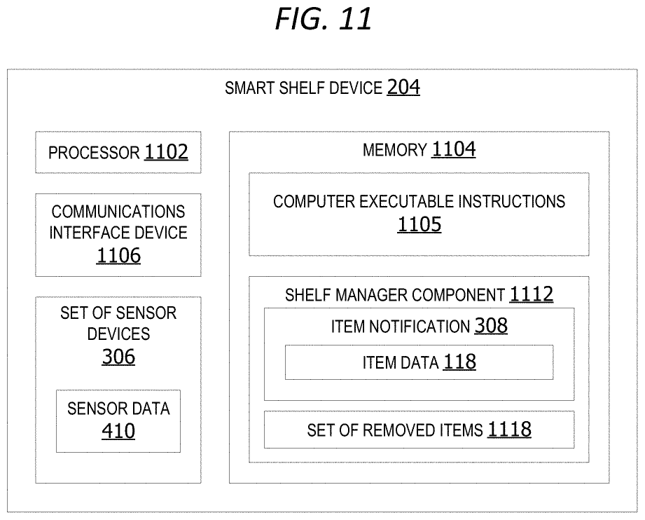

FIG. 11 is an exemplary block diagram illustrating a smart shelf device 204. The smart shelf device 204 includes at least one processor 1102 communicatively coupled to a memory 1104. The processor 1102 includes any quantity of processing units and is programmed to execute the computer-executable instructions 1105. The computer-executable instructions 1105 can be performed by the processor 1102 or by multiple processors within the smart shelf device 204 or performed by a processor external to the smart shelf device 204, such as a processor on one or more smart cart devices.

The smart shelf device 204 further has one or more computer-readable media such as the memory 1104. The memory 1104 includes any quantity of media associated with or accessible by the smart shelf device 204. The memory 1104 can be internal to the smart shelf device 204 (as shown in FIG. 11), external to the smart shelf device 204 (not shown), or both (not shown).

The memory 1104 stores data, such as one or more applications. The applications, when executed by the processor 1102, operate to perform functionality on the smart shelf device 204. The applications can communicate with counterpart applications or services such as web services accessible via a network, such as the network 110 in FIG. 1. For example, the applications can represent downloaded client-side applications that correspond to server-side services executing in a cloud.

In some examples, the smart shelf device 204 optionally includes a communications interface component 1106. The communications interface component 1106 includes a network interface card and/or computer-executable instructions (e.g., a driver) for operating the network interface card. Communication between the smart shelf device 204 and other devices, such as but not limited to, smart carts and other smart shelves, can occur using any protocol or mechanism over any wired or wireless connection. In some examples, the communications interface component 1106 is operable with short range communication technologies such as by using near-field communication (NFC) tags.

The smart shelf device 204 includes a set of sensor devices 306 for generating sensor data 410 associated with one or more items displayed on the smart shelf device 204. In some examples, the set of sensor devices 306 includes one or more weight sensors. When an item is removed or lifted off the shelf, the weight sensor(s) register a decrease in weight attributable to the removed item. If the item is returned to the shelf, the weight sensors register the increase in weight corresponding to the item being set back down on the shelf. If an item notification is sent out by the shelf for an item removed from the shelf which is subsequently replaced back onto the shelf, the shelf sends out a delete notification (confirmation) message to smart carts in range of the shelf instructing the smart carts to delete the item notification associated with the item returned to the shelf.

The memory 1104 in some examples stores one or more computer-executable components. Exemplary components include a shelf manager component 1112. The shelf manager component 1112 generates an item notification 308, including item data 118, describing a set of removed item 1118. The set of removed item 1118 includes one or more items displayed or resting on the smart shelf which is removed from the smart shelf for a threshold time-period without being returned/replaced back onto the shelf. The shelf manager component 1112 sends the item notification 308 to a set of smart carts within the notification zone (range) of the smart shelf. If none of the cart's returns a confirmation acknowledging that the set of removed items are placed into one or more of the carts, the cart manager component optionally re-sends the item notification periodically until a threshold wait-time has expired. Upon expiration of the wait-time, the smart shelf clears the item notification 308 from a shelf cache on the memory 1104.

In some examples, the smart shelf sends a portion of the analytics for identifying the set of removed items to one or more smart carts for execution on the one or more smart carts. In other examples, a smart cart sends a portion of the analytics for identifying items placed into the smart cart and determining whether an item added to the cart matches an item in the set of removed items to the smart shelf device 204 and/or one or more of the other smart carts.

This parallel processing on multiple smart carts and/or smart shelves can be managed by a load balancer in some non-limiting examples. The load distribution among smart carts and smart shelves improves processing speed, calculation efficiency, and further improves resource usage.

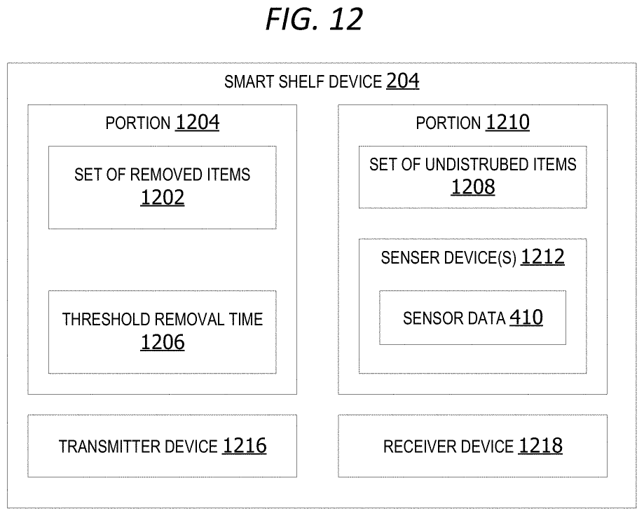

FIG. 12 is an exemplary block diagram illustrating a smart shelf device 204 having a plurality of items. The smart shelf device 204 in this example includes a set of removed items 1202 lifted or moved off a portion 1204 of the smart shelf device 204 for a threshold removal time 1206. The threshold removal time is the amount of time after an item is removed from the shelf prior to identifying the item as having been removed. For example, if the threshold removal time is one second, an item is not identified as being removed from the shelf unless it is lifted off the shelf for more than one second. If the item is lifted and then immediately replaced on the shelf in one second or less, an item notification is not sent out.

The threshold removal time is a user-configurable amount of time. In some examples the threshold removal time is five seconds. In other examples, the threshold removal time can be two seconds, or any other configurable time-period. The threshold removal time reduces the number of item notifications sent out for items which are only temporarily lifted off the shelf for a brief inspection by a customer to read labels or otherwise identify the item prior to returning/replacing the item back onto the shelf.

A set of undisturbed items 1208 is a set of one or more items which are assigned for display on the shelf and which have not been removed from a portion 1210 of the shelf. A set of one or more sensor devices 1212 generates sensor data 410 associated with the set of undisturbed items. If an item is lifted off the shelf, the sensor data identifies the removed item and/or generates item data describing the removed item. The item data can include a weight of the item based on an amount of weight decremented when the item is removed, size of the item, image of the item, etc.

The smart shelf device 204 can include a transmitter device 1216 for transmitting item notifications and/or a receiver device 1218 for receiving confirmation/acknowledge messages from smart carts. The transmitter device and the receiver device can be implemented within a single communications device.

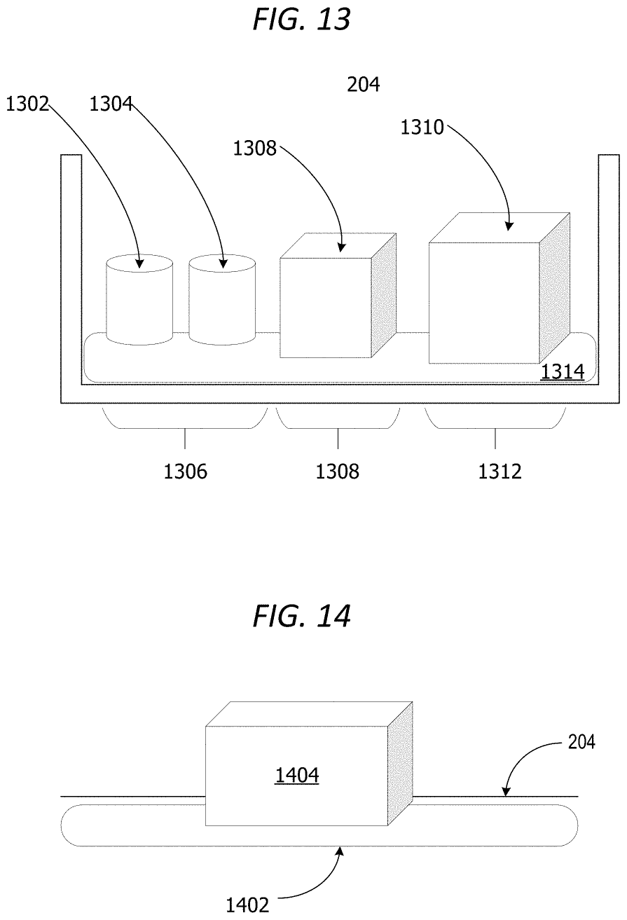

FIG. 13 is an exemplary block diagram illustrating a front view of a smart shelf device 204 including a plurality of sections. The smart shelf device 204 includes item 1204 and item 1304 in section 1306, item 1304 in section 1308 and item 1206 in section 1208. In this example, different items are assigned each section or portion of the shelf. The smart shelf device 204 includes a weight sensor 1314 on top of the bottom layer of the shelf.

In this example, a single weight sensor 1314 detects weight changes associated with all items on the shelf. In other examples, a different weight sensor is associated with each section of the shelf. For example, a first weight sensor associated with section 1306, a second weight sensor associated with section 1308 and a third weight sensor associated with section 1208.

FIG. 14 is an exemplary block diagram illustrating a smart shelf device 204 including a weight sensor 1402 located underneath the shelf 1206. When the item 1404 is placed onto the shelf 1206, the weight sensor 1402 detects an increase in weight. When the item 1404 is removed from the smart shelf device 204, the weight sensor registers a decrease in weight.

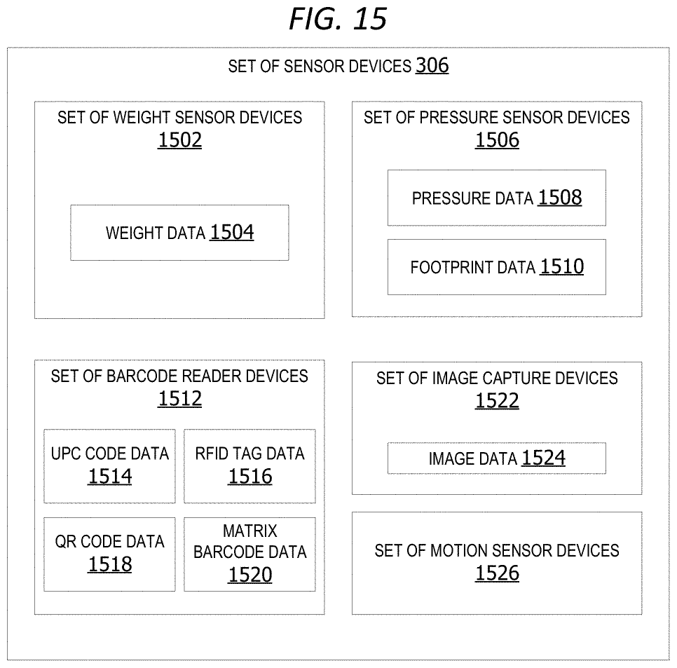

FIG. 15 is an exemplary block diagram illustrating a set of sensor devices 306. The set of sensor devices 306 includes sensor devices on smart cart devices as well as sensor devices on smart shelf devices.

The set of sensor devices 306 includes a set of one or more weight sensor devices 1502 in some examples. The set of weight sensor devices 1502 generates weight data 1504, including weight increases in response to items placed on the shelf and weight decreases (decrement) when items are removed/lifted off the shelf.

The set of sensor devices 306 in other examples includes a set of one or more pressure sensor devices 1506. The set of pressure sensor devices 1506 generates pressure data 1508 when an item is placed on a smart shelf (or into a smart shelf display) and/or when an item is removed from the smart shelf (or display). The set of pressure sensor devices 1506 also generates footprint data 1510. The footprint data 1510 identifies a shape of a top portion, bottom portion or side portion of an item (footprint) in contact with a shelf surface.

A set of one or more barcode reader devices 1512 generate barcode data obtained from scanning barcodes or other item identifiers. The set of barcode reader devices 1512 generates UPC code data 1514, RFID tag data 1516, QR code data 1 can 118 and/or matrix barcode data 1520.

In still other examples, the set of sensor devices 306 include a set of image capture devices 1522 generating image data 1524 associated with items removed from smart shelf devices or placed onto or into smart shelves/displays. An image capture device can be implemented as a camera, an infrared (IR) sensor and/or other optic sensors.

FIG. 16 is an exemplary flow chart illustrating operation of the smart cart device to monitor contents of a smart cart device. The process shown in FIG. 16 can be performed by a cart management component, executing on one or more smart cart devices, such as a smart cart device in the set of smart cart devices 106 or the user device 114 in FIG. 1.

The process begins by determining whether an item notification is received at 1602. The item notification is a notification such as, but not limited to, the item notification 308 in FIG. 3 above. The cart management component retrieves sensor data from cart sensor(s) at 1604. The cart management component analyzes the sensor data using item data obtained from the item notification at 1606. The cart management component determines whether an item is added to the cart at 1608. If no, the cart management component determines if a threshold wait time is expired at 1610. If no, the process returns to 1604 and iteratively executes operations 1604 through 1608 until an item is added to the cart or the threshold wait time is expired at 1610. If the wait time is expired, the cart management component deletes the notification at 1618 and the process terminates thereafter.

The cart management component determines whether an item added to the cart conforms to the removed item data in the item notification at 1612. If no, the process returns to 1610 to determine whether the threshold wait time is expired. If the wait time is expired, the cart management component deletes the notification at 1618 and the process terminates thereafter.

Returning to 1612, if the cart management component determines an item added to the cart conforms to an item identified in an item notification, the cart management component transmits a cart confirmation message at 1614. The cart management component updates a list of contents of the smart cart at 1616. The process terminates thereafter.

While the operations illustrated in FIG. 16 are performed by a smart cart device, aspects of the disclosure contemplate performance of the operations by other entities. For example, a cloud service can perform one or more of the operations.

FIG. 17 is an exemplary flow chart illustrating operation of the smart cart device to manage item notifications received from smart shelf devices. The process shown in FIG. 17 can be performed by a cart management component, executing on one or more smart cart devices, such as a smart cart device in the set of smart cart devices 106 or the user device 114 in FIG. 1.

The process begins by receiving an item notification from a smart shelf identifying one or more removed items at 1702. The cart management component updates cache 1704. The cache update in some examples includes saving the item notification into a cache on the smart cart device for a threshold time-period. The cart management component analyzes cart sensor data at 1706. The sensor data includes data generated by one or more sensor devices, such as, but not limited to, the sensor data 410 in FIG. 4, FIG. 5, FIG. 11 and FIG. 12 above.

The cart management component determines whether all items identified in the item notification are added to the smart cart device at 1708. If no, the cart management component determines whether confirmation is received from one or more other smart carts at 1710. If yes, the process returns to 1708. If all items are added to one or more smart carts at 1708, the cart management component sends a confirmation to the smart shelf at 1712. The smart shelf is a device such as, but not limited to, the smart shelf device 204 in FIG. 2. The cart management component deletes the notification from the cache at 1714. The process terminates thereafter.

Returning to 1710, if all items are not added to the smart cart and confirmations are not received from other smart carts, the cart management component determines if the wait time is expired. If yes, the process terminates thereafter.

While the operations illustrated in FIG. 17 are performed by a smart cart device, aspects of the disclosure contemplate performance of the operations by other entities. For example, a cloud service can perform one or more of the operations.

### ADDITIONAL EXAMPLES

In some examples, the system provides communication between a smart shopping cart and a product shelf. The system tracks the weight of an item removed/lifted off the smart shelf. Smart shelves within a predetermined distance of the smart shopping cart send an item notifications identifying an item removed from the smart shelf to the smart shopping cart in response to detecting removal of an item from a smart shelf within range of the cart.

The system in other examples compares the weight of an item removed from a shelf with weight changes/weight increases due to items added/placed into the cart within a predetermined time period of receiving the item notification. In other examples, the system utilized image data, barcode data, item footprint/pressure sensor data or any other type of data to detect removal of an item from a shelf and/or placement of an item into a smart cart.

The smart shopping cart in some examples includes a set of sensor devices monitoring items added to the smart shopping cart. The system utilizes the sensor data generated on the cart to identify items as the items are placed into the cart. If the smart shopping cart detects a weight increase associated with an item placed into the cart without receiving any item notifications, in other examples, the smart shopping cart sends a query to the smart shelf. The query requests verification/confirmation that no item has been removed from the shelf and/or requests identification of any items removed from smart shelf within a predetermined time-period prior to detection of the unknown item placed into the cart.

In this manner, the system provides a backward communication between smart carts within a notification range of one or more smart shelves. The system determines the identification of items added to smart shopping carts based on the smart shopping carts' locations in a store, weight changes associated with items added to each cart, notifications received from the smart shelves, notifications received from other smart shopping carts and/or items removed from smart shelves within a predetermined range of the smart shopping carts.

In an example scenario, a scanner or other sensor device is attached to the smart cart device. The user pairs a user device, such as a smart phone, with the smart cart management component. When an item is picked for purchase, the shopper drops the item into the cart. As the item is placed into the cart, scanners in the cart or attached to the cart scans the item. In one example, the cart includes a sensor tunnel. When an item is dropped through the tunnel, the tunnel scans the item for barcodes or other identifying features. In still other examples, the smart cart management component can be paired with a self-checkout scan and go system for completing a purchase transaction of items in the cart without using a traditional POS device at a checkout.

The smart cart in some examples includes a cart design that prevents items in the basket from piling up inside the basket to improve accuracy of sensor data generated by the cart sensor devices.

System integration between the carts and the shelves provides verification and integration of pairing to cart for automatic payment. In other words, the cart acts as a virtual POS for completing purchase of items in the smart shopping cart without going through a physical POS device and/or without scanning items with a scanner device at the physical POS device. The carts and shelfs communicate via a network to determine location of items and/or cart contents without a server or other computing device. The shelves and carts operate autonomously without complex store system architecture.

The system provides exception handling in other examples. If an item is placed into a smart cart but the item fails to scan (unscanned item) or the scan data/sensor data fails to identify the item, the system outputs a query requesting a user manually scan the item or manually identify the item. In some examples, the item can be manually scanned using the user device, a hand-held scanner, or a scanner on the cart. Likewise, the user can manually remove/delete items from the list of items (cart contents inventory) in the cart when the user removes an item from the cart and/or chooses not to purchase an item in the cart.

In one example, a customer at the dairy section of a store selects a yogurt from a smart shelf. The smart shelf knows what items are shelved there and how many items have been removed. The smart shelf can utilize incremental weight to determine how many (number/instances) of the item are taken. The shelf informs/notifies nearby smart carts that these items and their corresponding weights were just lifted off the shelf and likely to be placed in a cart nearby. The cart that sees that exact weight added shortly thereafter, adds that item in that quantity to the purchase list.

In another illustrative example, if there are two shoppers in the dairy and one shopper selects a gallon of chocolate mile and the other shopper selects a gallon of whole milk, barcode scanners on each cart can be utilized to determine which cart received the chocolate milk and which cart received the whole milk.

Cameras are utilized in other examples to identify items placed in smart carts where multiple different items having standardized weights are placed into a cart. The camera generates images lifting the main color of the product as it is placed into the cart. The image data assists with confirming which item is placed into which cart. For example, boxes of cereal are sold by the same weight, but with wildly different colors. Likewise, milk varieties are typically identified by the color of the label on the milk jug or carton.

A manual override by a user is provided for a case when something is added to a cart without a corresponding shelf pick. Likewise, if an item is removed from the cart prior to completing the transaction (before checkout), a manual override or manual input can be provided by a user to identify the removed item.

In another non-limiting example, if a cart detects an unknown item of some measured weight added to the basket, the cart can reach out to the shelves in the area to inquire whether any of them had an item of that weight, size and/or color on the shelf. The system optionally prompts the customer with a short list of possible items if multiple shelves respond to the cart with multiple possible picks. If the item is not on that list, the shelf is malfunctioning or if nothing is returned, then a wider query is made by the cart to a store database/data storage device for a list of possible items conforming to the item data for the newly added unidentified item based on the customer's location in the store. The customer is presented with that short list of possible conforming items. The user selects the correct item from the output list. The list can be output on the cart's user interface or the user device.

Alternatively, or in addition to the other examples described herein, examples include any combination of the following:
the cache manager component, implemented on the at least one processor, deletes the item notification from a cart cache on condition a set of confirmation messages received from a set of smart cart devices within the notification zone of the smart shelf device indicates all items in the set of removed items are added to at least one smart cart device within the notification zone;
the cache manager component, implemented on the at least one processor, deletes the item notification from a cart cache on condition a threshold wait time after receiving the item notification expires;
an analysis component, implemented on the at least one processor, compares weight sensor data generated by at least one weight sensor associated with the storage area of the first smart cart device with item data, including weight data, associated with the set of removed items to determine whether the at least one selected item added to the storage area of the first smart cart matches at least one of the items in the set of removed items;
an analysis component, implemented on the at least one processor, compares image data generated by at least one image capture device associated with the storage area of the first smart cart device with item data, including image data, associated with the set of removed items to determine whether the at least one selected item added to the storage area of the first smart cart device matches at least one of the items in the set of removed items;
the verification component, implemented on the at least one processor, outputs an item identification query to a user via a user interface device associated with the first smart cart device on condition the sensor data generated by the set of cart sensor devices indicates at least one item added to the storage area is non-conforming with any item in the set of removed items;
wherein the item identification query prompts the user to manually identify the at least one item or manually scan a barcode associated with the at least one item;
the verification component, implemented on the at least one processor, outputs an item identification query to a user interface device associated with the first smart cart device on condition at least one item notifications associated with a plurality of items removed from at least one smart shelf device within a predetermined time-period is received and the sensor data associated with the at least one selected item conforms with two or more different items in the plurality of removed items;
wherein the item identification query prompts the user to manually identify the at least one item from a list identifying the two or more different items;
the verification component, implemented on the at least one processor, outputs an item identification query to a user via a user interface device associated with the first smart cart device on condition the sensor data generated by the set of cart sensor devices indicates removal of at least one item from the storage area of the first smart cart device, wherein the item identification query prompts the user to identify the at least one item removed from the storage area of the first smart cart device;
a transaction completion component, implemented on the at least one processor, completes a user purchase of the set of selected items in the storage area of the first smart cart device based on a set of values associated with each item in the list of contents of the first smart cart device;
a transaction completion component, implemented on the at least one processor, receives an updated set of values for at least one item in the list of contents of the first smart cart device from a remote data storage device via a network;
updating, by a basket update component, a list of contents of the first smart cart device to include the removed item on condition the verification component verifies the removed item described in the first item notification conforms to an item added to the first smart cart;
removing, by a cache manager component, the item notification from a cart cache on condition a second cart confirmation associated with the removed item is received from a second smart cart device prior to expiration of the threshold wait time;
deleting, by a shelf cache manager component, the item notification from a shelf cache on condition a cart notification is received from at least one smart cart device;
deleting, by a shelf cache manager component, the item notification from a shelf cache on condition a wait time threshold expires;
outputting, by a user interface device, an item identification query prompting a user to manually identify an item added to the storage area on the first smart cart device on condition the item added to the storage area fails to conform with item data in an open item notification;
deleting, by a cache manager component, the item notification from a cart cache on condition the sensor data generated by the set of sensor devices fails to identify an item conforming to the item data associated with the removed item;
performing, by a first processor on a first smart cart device, a first portion of cart content analytics;
performing, by a second processor on a second smart cart device, a second portion of the cart content analytics, wherein the first smart cart device transmits a result of the first portion of the cart content analytics to the second smart cart device;
a coupon container configured to accept physical coupons utilized during completion of the transaction; and
wherein the set of sensor devices further comprises at least one of a set of weight sensor devices, a set of image capture devices, a set of pressure sensor devices and a set of barcode reader devices.

At least a portion of the functionality of the various elements in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14 and FIG. 15 can be performed by other elements in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14 and FIG. 15, or an entity (e.g., processor, web service, server, application program, computing device, etc.) not shown in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14 and FIG. 15.

In some examples, the operations illustrated in FIG. 16 and FIG. 17 can be implemented as software instructions encoded on a computer-readable medium, in hardware programmed or designed to perform the operations, or both. For example, aspects of the disclosure can be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH®” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice is provided to the users of the collection of the data (e.g., via a dialog box or preference setting) and users are given the opportunity to give or deny consent for the monitoring and/or collection. The consent can take the form of opt-in consent or opt-out consent.

### Exemplary Operating Environment

Exemplary computer-readable media include flash memory drives, digital versatile discs (DVDs), compact discs (CDs), floppy disks, and tape cassettes. By way of example and not limitation, computer-readable media comprise computer storage media and communication media. Computer storage media include volatile and nonvolatile, removable and non-removable media implemented in any method or technology for storage of information such as computer-readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer-readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that can be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices can accept input from the user in any way, including from input devices such as a keyboard or pointing device, via gesture input, proximity input (such as by hovering), and/or via voice input.

Examples of the disclosure can be described in the general context of computer-executable instructions, such as program modules, executed by one or more computers or other devices in software, firmware, hardware, or a combination thereof. The computer-executable instructions can be organized into one or more computer-executable components or modules. Generally, program modules include, but are not limited to, routines, programs, objects, components, and data structures that perform tasks or implement abstract data types. Aspects of the disclosure can be implemented with any number and organization of such components or modules. For example, aspects of the disclosure are not limited to the specific computer-executable instructions or the specific components or modules illustrated in the figures and described herein. Other examples of the disclosure can include different computer-executable instructions or components having more functionality or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for dynamically identifying cart contents via item notifications and cart confirmation messages sent in real-time. For example, the elements illustrated in FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14 and FIG. 15, such as when encoded to perform the operations illustrated in FIG. 16 and FIG. 17, constitute exemplary means for receiving an item notification including item data associated with a removed item in a plurality of items removed from a portion of a smart shelf device for a threshold removal time; exemplary means for analyzing sensor data generated by at least one sensor device associated with a set of selected items added to a storage area of the first smart cart device; exemplary means for determining if a selected item in the set of selected items conforms to the removed item; exemplary means for transmitting a first cart confirmation message confirming addition of the removed item to the first smart cart device on condition item data associated with the selected item conforms to item data associated with the removed item; and exemplary means for removing the item notification from a cart cache on condition a threshold wait time expires prior to detecting addition of an item to the storage area conforming to the item data associated with the removed item.

Other non-limiting examples provide one or more computer storage devices having a first computer-executable instructions stored thereon for providing notifications from a smart shelf to one or more smart carts in a notification zone. When executed by a computer, the computer performs operations including analyzing sensor data to identify items removed from a shelf and analyze cart sensor data to determine which smart cart the identified item is placed into by a user.

The order of execution or performance of the operations in examples of the disclosure illustrated and described herein is not essential, unless otherwise specified. That is, the operations can be performed in any order, unless otherwise specified, and examples of the disclosure can include additional or fewer operations than those disclosed herein. For example, it is contemplated that executing or performing an operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there can be additional elements other than the listed elements. The term “exemplary” is intended to mean “an example of” The phrase “one or more of the following: A, B, and C” means “at least one of A and/or at least one of B and/or at least one of C.”

In an exemplary embodiment, one or more of the exemplary embodiments include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system can be reduced significantly. For example, whenever localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data can include a key kernel index summary of the data as created under nominal conditions. In an exemplary embodiment, the kernel encodes relatively recently acquired intermittent data (“KRI”). As a result, in an exemplary embodiment, KRI includes a continuously utilized near term source of data, but KRI can be discarded depending upon the degree to which such KRI has any value based on local processing and evaluation of such KRI. In an exemplary embodiment, KRI may not even be utilized in any form if it is determined that KRI is transient and can be considered as signal noise. Furthermore, in an exemplary embodiment, the kernel rejects generic data to provide a modified kernel (“KRG”) by filtering incoming raw data using a stochastic filter that thereby provides a predictive model of one or more future states of the system and can thereby filter out data that is not consistent with the modeled future states which can, for example, reflect generic background data. In an exemplary embodiment, KRG incrementally sequences all future undefined cached kernels of data to filter out data that can reflect generic background data. In an exemplary embodiment, KRG further incrementally sequences all future undefined cached kernels having encoded asynchronous data to filter out data that can reflect generic background data.

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for dynamic identification of cart contents via item notifications, the system comprising:
a plurality of items associated with a smart shelf device;
a communications interface device associated with the smart shelf device, the communication interface device sends an item notification including item data associated with a set of removed items in the plurality of items removed from a portion of the smart shelf device for a threshold removal time;
a set of smart cart devices located within a notification zone of the smart shelf device, the set of smart cart devices comprising a first smart cart device and a second smart cart device, the first smart cart device comprising:
a control device comprising at least one processor communicatively coupled to a memory;
a set of cart sensor devices generating sensor data associated with a set of selected items added to a storage area of the first smart cart device;
an analysis component, implemented on the at least one processor, analyzes the sensor data associated with at least one selected item added to the storage area within a threshold time-period of receiving the item notification to determine whether the at least one selected item conforms to an item in the set of removed items;
a verification component, implemented on the at least one processor, transmits a cart confirmation message identifying the at least one selected item to the smart shelf device and the second smart cart on condition the at least one selected item conforms to the at least one removed item in the set of removed items;
a basket update component, implemented on the at least one processor, adds the at least one selected item to a list of contents of the first smart cart; and
a cache manager component, implemented on the at least one processor, deletes the item notification from a cart cache on condition all items in the set of removed items are added to the list of contents of the first smart cart.

2. The system of claim 1, further comprising:
the cache manager component, implemented on the at least one processor, deletes the item notification from the cart cache on condition a set of confirmation messages received from the set of smart cart devices within the notification zone of the smart shelf device indicates all items in the set of removed items are added to at least one smart cart device within the notification zone.

3. The system of claim 1, further comprising:
the cache manager component, implemented on the at least one processor, deletes the item notification from the cart cache on condition a threshold wait time after receiving the item notification expires.

4. The system of claim 1, further comprising:
the analysis component, implemented on the at least one processor, compares weight data generated by at least one weight sensor associated with the storage area of the first smart cart device with the item data, including the weight data, associated with the set of removed items to determine whether the at least one selected item added to the storage area of the first smart cart matches at least one of the items in the set of removed items.

5. The system of claim 1, further comprising:
the analysis component, implemented on the at least one processor, compares image data generated by at least one image capture device associated with the storage area of the first smart cart device with the item data, including the image data, associated with the set of removed items to determine whether the at least one selected item added to the storage area of the first smart cart device matches at least one of the items in the set of removed items.

6. The system of claim 1, further comprising:
the verification component, implemented on the at least one processor, outputs an item identification query to a user via a user interface device associated with the first smart cart device on condition the sensor data generated by the set of cart sensor devices indicates at least one item added to the storage area is non-conforming with any item in the set of removed items, wherein the item identification query prompts the user to manually identify the at least one item or manually scan a barcode associated with the at least one item.

7. The system of claim 1, further comprising:
the verification component, implemented on the at least one processor, outputs an item identification query to a user interface device associated with the first smart cart device on condition at least one item notification associated with the plurality of items removed from at least one smart shelf device within a predetermined time-period is received and the sensor data associated with the at least one selected item conforms with two or more different items in a plurality of removed items, wherein the item identification query prompts a user to manually identify the at least one item from a list identifying the two or more different items.

8. The system of claim 1, further comprising:
the verification component, implemented on the at least one processor, outputs an item identification query to a user via a user interface device associated with the first smart cart device on condition the sensor data generated by the set of cart sensor devices indicates removal of at least one item from the storage area of the first smart cart device, wherein the item identification query prompts the user to identify the at least one item removed from the storage area of the first smart cart device.

9. The system of claim 1, further comprising:
a transaction completion component, implemented on the at least one processor, completes a purchase of the set of selected items in the storage area of the first smart cart device based on a set of values associated with each item in the list of contents of the first smart cart device.

10. The system of claim 1, further comprising:
a transaction completion component, implemented on the at least one processor, receives an updated set of values for at least one item in the list of contents of the first smart cart device from a remote data storage device via a network.

11. A computer-implemented method for dynamically identifying items placed into a smart cart device, the computer-implemented method comprising:
receiving, by a communications interface device associated with a first smart cart device, an item notification including item data associated with an item in a plurality of items removed from a portion of a smart shelf device for a threshold removal time;
analyzing, by an analysis component, sensor data generated by at least one sensor device associated with a set of selected items added to a storage area of the first smart cart device;
determining, by a verification component, whether a selected item in the set of selected items conforms to the removed item;
transmitting, by the verification component, a first cart confirmation message confirming addition of the removed item to the first smart cart device on condition the item data associated with the selected item conforms to the item data associated with the removed item; and
removing, by a cache manager component, the item notification from a cart cache on condition a threshold wait time expires prior to detecting addition of an item to the storage area conforming to the item data associated with the removed item.

12. The computer-implemented method of claim 11, further comprising:
updating, by a basket update component, a list of contents of the first smart cart device to include the removed item on condition the verification component verifies the removed item described in the item notification conforms to an item added to the first smart cart.

13. The computer-implemented method of claim 11, further comprising:
removing, by the cache manager component, the item notification from the cart cache on condition a second cart confirmation associated with the removed item is received from a second smart cart device prior to expiration of the threshold wait time.

14. The computer-implemented method of claim 11, further comprising:
sending an item identification query to a set of smart shelf devices within a notification zone of the smart cart device on condition an unidentified item is added to the storage area of the smart cart device, wherein the item identification query comprises unidentified item data associated with the unidentified item; and
receiving displayed item data associated with a set of items displayed on the set of smart shelf devices conforming to the unidentified item data associated with the unidentified item added to the smart cart device; and
the smart cart device analyzes the displayed item data to identify the unidentified item, wherein the smart cart device determines whether the unidentified item is an item removed from the set of smart shelf devices within the notification zone.

15. The computer-implemented method of claim 11, further comprising:
performing, by a first processor on the first smart cart device, a first portion of cart content analytics; and
performing, by a second processor on a second smart cart device, a second portion of the cart content analytics, wherein the first smart cart device transmits a result of the first portion of the cart content analytics to the second smart cart device.

16. The computer-implemented method of claim 11, further comprising:
outputting, by a user interface device, an item identification query prompting a user to manually identify an item added to the storage area on the first smart cart device on condition the item added to the storage area fails to conform with the item data in an open item notification.

17. A smart cart device comprising:
a basket;
a set of wheels;
a set of sensor devices generating sensor data associated with a set of selected items placed into the basket;
a control device comprising a processor and a memory communicatively coupled to the processor;
a receiver device receives an item notification from a set of smart devices within a notification zone, the item notification comprising item data describing a selected item removed from a smart shelf device in a set of smart shelf devices;
a transmitter device sends a cart confirmation to the set of smart shelf devices in response to detection of an item added to the basket conforming to the item data describing the selected item removed from the smart shelf device;
a basket update component, implemented on the at least one processor, adds the selected item to a list of contents of a first smart cart on condition the cart confirmation is sent; and
a transaction completion component, implemented on the at least one processor, that completes a transaction associated with a list of items on condition transaction completion input is received from a user.

18. The smart cart device of claim 17, further comprising:
deleting, by a cache manager component, the item notification from a cart cache on condition the sensor data generated by the set of sensor devices fails to identify an item conforming to the item data associated with the removed item.

19. The smart cart device of claim 17, further comprising:
a coupon container configured to accept physical coupons utilized during completion of the transaction.

20. The smart cart device of claim 17, wherein the set of sensor devices further comprises at least one of a set of weight sensor devices, a set of image capture devices, a set of motion sensor devices, a set of pressure sensor devices and a set of barcode reader devices.
